(19) United States
(12) Patent Application Publication
(10) Pub. No.: US 2004/0089394 A1
(43) Pub. Date: May 13, 2004

(54) Controller for corrugating machine and method

(76) Inventors: Christopher Guilmartin, Medway, MA (US); Lawrence Wickenheisher, Miami Beach, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/640,178

(22) Filed: Aug. 13, 2003

Related U.S. Application Data
(60) Provisional application No. 60/403,147, filed on Aug. 13, 2002.

(51) Int. Cl. B32B 31/00

(52) U.S. Cl. 156/64; 156/351; 156/205

(57) ABSTRACT

A control system for a corrugating machine and a method for determining a length of paper web in a corrugating machine having a bridge are disclosed, the method including the steps of calculating an approximate length of the paper web on the bridge using photoelectric detectors, applying a liquid pattern on a portion of the paper web for a short duration, initiating a count at the application of the liquid pattern, detecting the liquid pattern with a moisture detector, terminating the count at the detection of the liquid pattern, calculating a determined length of the paper web based on the count and the detection of the liquid pattern, comparing the determined length to the approximate length, and adjusting the approximate length to equal the determined length.

### CROSS-REFERENCES TO RELATED APPLICATIONS

This application claims the benefit of U.S. Provisional Application Serial No. 60/403,147, filed on Aug. 13, 2002, entitled CONTROLLER FOR CORRUGATING MACHINE AND METHOD.

### TECHNICAL FIELD

This invention relates generally to a controller for a corrugating machine for producing corrugated paperboard and methods for using the same. In particular, the controller for a corrugating machine and methods relate to generating a synchronized splice by comparing a plurality of variables for automatically determining the length of the web material in the bridge of the machine.

### BACKGROUND OF THE INVENTION

Conventional corrugating machines produce single-wall, double-wall and triple-wall corrugated board from multiple continuous webs of flat paper and an additional continuous web of corrugated paper. The prior art has produced a corrugating machine where a pair of corrugating rollers corrugates a web of paper and glues it to a web of flat paper in order to produce a single-faced corrugated web, which is supplied to the bridge of the corrugating machine.

Each of the paper webs employed to form the single-faced corrugated web is fed from a large roll of paper, which periodically runs out. As one of the paper rolls runs out of paper, a paper web from a new roll is spliced onto the paper web from the old roll via a conventional splicer. A new roll may also be spliced in when the corrugator has produced the required quantity of corrugated board with the current paper composition and it is desired to start producing board of a new paper composition (known as a paper change).

In order to accommodate the splicing of the new roll to the old roll, the portion of the corrugating machine which produces single-faced corrugated board may be slowed somewhat; consequently, the single-faced corrugated web is provided to the bridge at a speed that is variable. The single-faced corrugated web is drawn from the bridge of the corrugating machine and is bonded to a third web of paper to produce single-wall corrugated web, which is then supplied to a conventional cutter which cuts the single-wall corrugated web into the desired sizes.

When one of the paper webs forming the single-faced corrugated board is spliced by one of the splicers, the web portion in which the splice is made is often twice as thick as usual (due to overlap of the original paper web with the new paper web) and contains tape to hold the new paper web to the original paper web. This extra-thick, taped web portion is undesirable and may be automatically cut out by the cutter (which may be the main cutter or an auxiliary cutter) after the single-wall corrugated web is produced. If a paper change is in progress then it is desirable to synchronize the changing of the paper webs with each other and with the cutter so as to provide an efficient transition between orders with a minimum amount of wasted paper.

The prior art corrugating machine described above incorporates a method of automatically cutting out the extra-thick, taped web portion based upon a procedure that periodically determines the length of the web that was in the bridge portion of the corrugating machine. As the single-faced corrugated web was supplied to the bridge at a variable rate and thereby removed from the bridge at a variable rate, the length of the web in the bridge at any time was also variable.

In the prior art method, the length of the web in the bridge was determined, and then the total length of the web from one of the splicers to the cutter was determined based thereon (the length of the web from one of the splicers to the bridge was a known constant, and the length of the web from the bridge to the cutter was a known constant). As soon as a splice was made, the corrugating machine would start measuring the web length from the splicer to the cutter. When the machine had measured a web length that was slightly less than the total web length, the cutter would make a first cut, wait for a predetermined period of time or a distance, and then make a second cut. This resulted in the extra-thick spliced portion of the web would be cut out from the web.

In the prior art method of determining the length of the web in the bridge, an ink or other liquid mark was sprayed onto a portion of the single-faced corrugated web just prior to its entry into the bridge. An ink mark or other reflectance detector was positioned at the exit of the bridge, and a measuring wheel that abutted against the single-face top liner or medium web generated a plurality of counts in direct proportion to the travel of the single-faced corrugated web. The length of the single-faced web in the bridge was determined based on the number of pulses that were generated by the measuring wheel as well as any movement by the dancer rollers or preheater or preconditioner wrap arms between the time the ink or other liquid mark was sprayed and the time the ink or other liquid mark was later detected by the detector. This manner of determining the length of the single-faced corrugated web in the bridge is generally advantageous in that it allows the splice to be more precisely cut out, without the need to cut out larger adjacent portions of the web that are acceptable for use.

Other methods of determining the length of the web in the bridge, such as the use of metal foil pieces that are adhesively applied to the web, are relatively expensive and have other disadvantages including maintenance problems.

In addition, none of the prior art corrugating machines includes control mechanisms that can compare a plurality of variables to automatically and more accurately determine the length of the web material in the corrugating machine in order to create a synchronous splice of all paper webs. Such variables include the position of the pre-heater arms, the dancer roll position, and moisture content of the web. Thus, there exists a need for a controller for corrugating machines that can compare a plurality of variables to automatically and more accurately and cost-effectively determine the length of the web material in the corrugating machine in order to create a synchronous splice of all paper webs.

### SUMMARY OF THE INVENTION

The present invention provides a controller for corrugating machines that can compare a plurality of variables and a method for accurately determining the length of the web material in the corrugating machine in order to create a synchronous splice. Such variables can include the position of the pre-heater arms and the dancer roll position within the splicer.

In accordance with the present invention, there is provided a control system for a corrugating machine, including a first positionable dancer roll for manipulating a first paper web operatively engaged to a controller, a first positionable pre-heater wraparm for adjusting an amount of the first paper web in contact with the positionable pre-heater operatively engaged to the controller, a second positionable dancer roll for manipulating a second paper web operatively engaged to the controller, a second positionable pre-heater wraparm for adjusting an amount of the second paper web in contact with the positionable pre-heater operatively engaged to the controller, a roller assembly for corrugating the second paper web and adhering the first paper web to the second paper web to form layered paper web, a moisture applicator for applying moisture to the first paper web and operatively engaged to the controller, a bridge for temporarily storing the layered paper web, a plurality of photoelectric detectors positioned on the bridge of the corrugating machine and operatively engaged to the controller, a moisture detector to detect the presence of moisture of the first paper web and operatively engaged to the controller, wherein the moisture detector adjusts the plurality of photoelectric detectors, at least one splicer operatively engaged to the controller for cutting out a portion of the layered paper web at a synchronized splice point, wherein the synchronized splice point is determined by correlating said plurality of photoelectric detectors with the moisture detector.

The present invention is further directed to a method for determining a length of paper web in a corrugating machine having a bridge, the method including the steps of calculating an approximate length of the paper web on the bridge using photoelectric detectors, applying a liquid pattern on a portion of the paper web for a short duration, initiating a count at the application of the liquid pattern, detecting the liquid pattern with a moisture detector, terminating the count at the detection of the liquid pattern, calculating a determined length of the paper web based on the count and the detection of the liquid pattern, comparing the determined length to the approximate length, and adjusting the approximate length to equal the determined length.

The present invention is additionally directed to a moisture detector for a control system for a corrugating machine, including a lamp for emitting light towards a paper web, a detector for detecting wavelengths of the light reflected off of the paper web, the detector generating an electrical signal indicative of the wavelengths of the reflected light, an amplifier in electrical communication with the detector, the amplifier amplifying the electrical signal, a differential amplifier in electrical communication with the amplifier, the differential amplifier receiving the electrical signal and differentially amplifying the electrical signal, an analog-to-digital converter in electrical communication with the differential amplifier, the analog-to-digital converter converting the differentially amplified electrical signal to a digital signal indicative of the wavelengths of the reflected light, a central processing unit in electrical communication with the analog-to-digital converter, the central processing unit receiving the digital signal and containing software to maintain a fluid offset and identifying the digital signal indicative of the wavelengths of the reflected light, and wherein the central processing unit includes an output to transmit the digital signal indicative of the wavelengths of the reflected light to a controller.

### BRIEF DESCRIPTION OF THE DRAWINGS

FIG. 1A is a schematic side view of a first portion of the preferred embodiment of the present invention.

FIG. 1B is a schematic side view of a second portion of the present invention of FIG. 1A.

FIG. 2 is a flow chart of the method of determining the length of the web in the bridge of the corrugating machine of FIGS. 1A and 1B.

FIG. 3 is a flow chart of the method of determining the synchronous splice point in accordance with the method of FIG. 3.

FIG. 4 is a component diagram of a moisture detector in accordance with the present invention.

### DETAILED DESCRIPTION

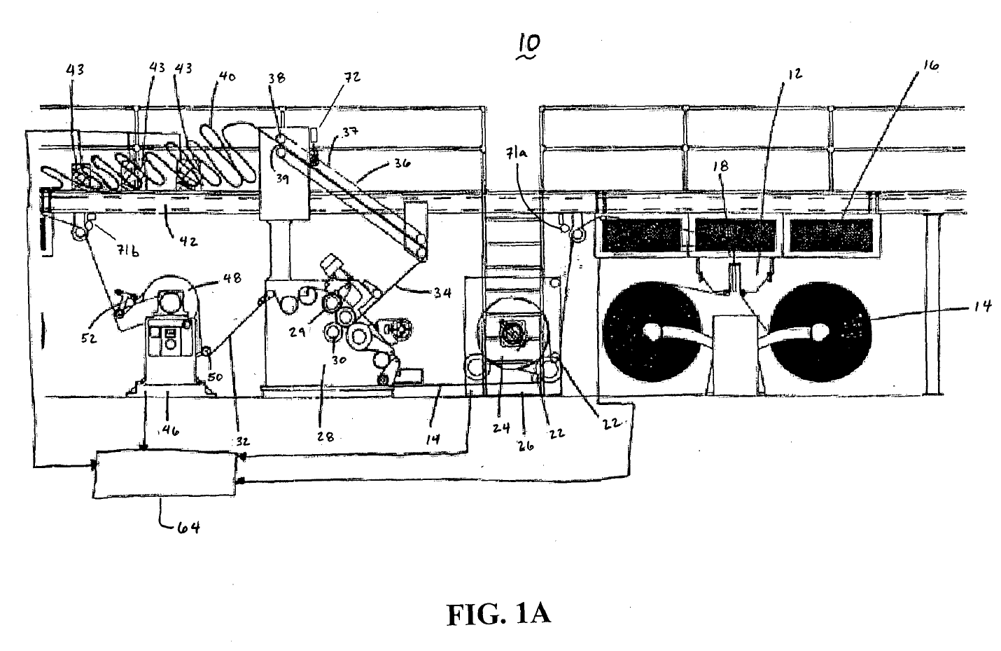

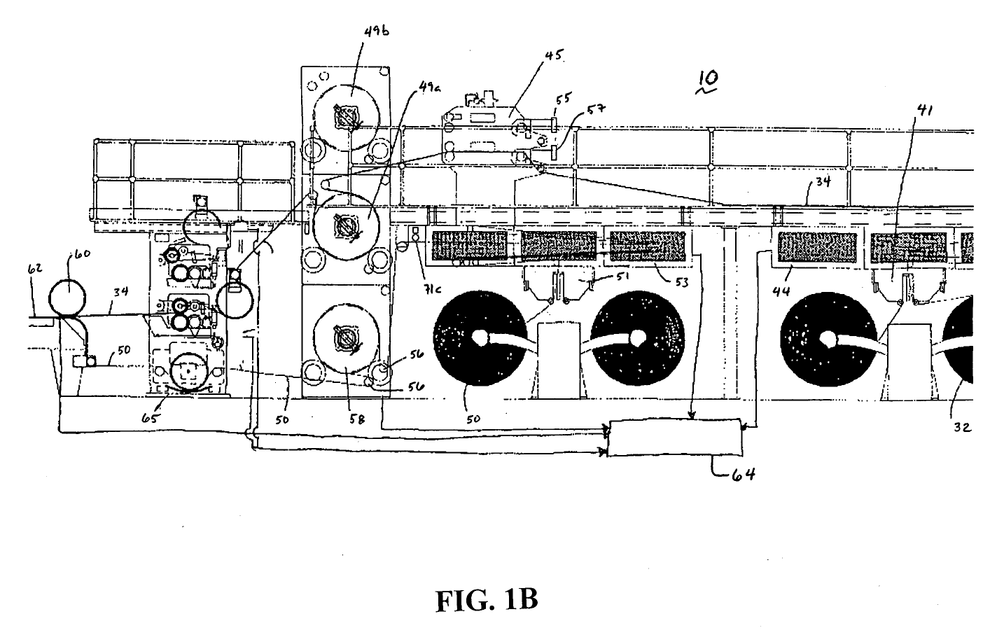

FIG. 1A illustrates a first portion of a preferred embodiment of a corrugating machine 10 in accordance with the present invention. Referring to FIG. 1A, corrugating machine 10 includes a conventional splicer 12 that supplies a paper web 14 from a paper roll to cylindrical idler roller 18 rotatably supported by a support member attached to a frame portion. The average size of paper roll is approximately 25,000 lineal feet, having a width of about 48 inches to about 108 inches. Paper web 14 passes through splicer 12, then further passes through positionable dancer roll 16, positionable dancer roll 16 for providing constant tension of the paper roll so that paper rolls can be properly adhered together under measuring wheel 71a, then underneath a pair of positionable cylindrical rollers 22, positionable cylindrical rollers 22 for adjusting the amount of paper on a wraparm and over a portion of a pre-heating roller 24 supported by a frame portion 26. For example, by adjusting the position of positionable cylindrical rollers 22 relative to pre-heating roller 24, web 14 can be heated to different degrees. By increasing the amount of web 14 that passes over pre-heating roller 24, positionable cylindrical rollers 22 cause web 14 to be heated to a higher temperature. Similarly, by decreasing the amount of web 14 that passes over pre-heating roller 24, positionable cylindrical rollers 22 cause web 14 to be heated less. Web 14 passes through roller assembly 28 for bonding to a corrugated web, such as paper web 32 described below. Computer-operated controller 64 tracks the paper moving under measuring wheel 71. Controller 64 also tracks the position of dancer roll 16, either via a pulse wheel, analog signal from a potentiometer, or load cell that changes proportionally with the position of the dancer roll. Controller 64 is also capable of tracking the position of cylindrical rollers 22 via an analog signal from a potentiometer that changes proportionally with the roller position.

Corrugating machine 10, illustrated in FIG. 1B, includes a second conventional splicer 41 that supplies a second paper web 32 from another paper roll to another cylindrical idler roller also rotatably supported by a support member attached to the frame portion. As with paper web 14, paper web 32 passes through splicer 41 then further passes through positionable dancer roll 44, under measuring wheel 71b, then underneath a pair of positionable cylindrical rollers 50 and 52, and over a portion of a pre-heating roller 48 supported by a frame portion 46. Web 32 passes between a pair of corrugating rollers 29, each of which has a corrugating surface to corrugate web 32, as is known in the art. An adhesive, such as glue, including but not limited to, corn starch and potato starch is applied to the top portions of corrugated web 32 via a conventional apparatus in the form of a pair of adhesive applicator rollers 30.

Paper web 14 is adhesively bonded to the corrugated web 32 when the webs 14 and 32 come into contact together at the junction of the rollers in roller assembly 28 so that a single-faced corrugated web 34 is formed. Web 34 is transported to a bridge 42 via a conveyor mechanism 36 composed of a pair of conveyors, each of which has a pair of rollers 38 which support a respective conveyor belt 37, with the web 34 passing between the conveyor belts 37 through an aperture 39 formed in the bridge 42. Conveyor mechanism 36 supplies web 34 to bridge 42 at a rate which may be many times greater than the speed at which web 34 is conveyed along bridge 42 by a number of bridge conveyor belts (not shown). When supplied to bridge 42, a portion of web 34 often automatically folds over itself a number of times as shown in FIG. 1A. The purpose of bridge 42 is to store and create a buffer of excess single face web in the system

Single-faced corrugated web 34 may be selectively sprayed with water at a spot or location on the web 34 via a spraying apparatus with a spray nozzle 72 upon the receipt of an electrical spray signal generated by controller 64. Duration of a spray is between one-tenth and one-half of a second, and preferably approximately one-sixth of a second. In the preferred embodiment of the present invention, there is a plurality of sprays of such duration, with a predetermination period of time between sprays, in combination with the known speed of the web, yields a determinable distance between sprays. The duration of the sprays in the present invention are of much shorter duration than the sprays in the prior art, resulting in less water spray volume, and thereby preserve product quality by preventing warping and delamination of the web due to the presence of excess water. Moisture detectors 55 or 57 sense the presence of the sprayed water on web 34 as web 34 is pulled past them. Prior art detection systems utilize temperature sensors to detect a large-volume water spray. The difficulties that arise from the temperature sensing systems of the prior art are numerous. For example, water sprayed on the web has a temperature approximately equivalent to the temperature of the web, due to the water stored near the system. The resulting lack of temperature difference makes the water difficult to detect, and often results in the need to dump the standing water and refill the water supply with cooler water. Moreover, the prior art system requires significantly more water to be sprayed on the web in order to be detected, since water is typically not sprayed on the side that the temperature sensor views or senses. The excess water results in warping and/or delamination

Moisture detectors 55 and 57 of the present invention perform a spectral analysis of web 34. Light emitted by moisture detectors 55 and 57 is reflected off of web 34 and analyzed by one or both of moisture detectors 55 or 57 for the wavelengths of light reflected. For example, light reflected off of a dry web has different wavelength components that light reflected off of a web that is moist with water provided by nozzle 72. By providing sprays of short duration and low water volume, the present invention reduces the frequency of detecting false positives and missing false negatives that are replete in the prior art. False positive detections result from changes in paper type, condensation dripping on the web, as well as a multitude of other factors. False negatives typically result from having to lower the detection threshold of a temperature sensor or other prior art detector.

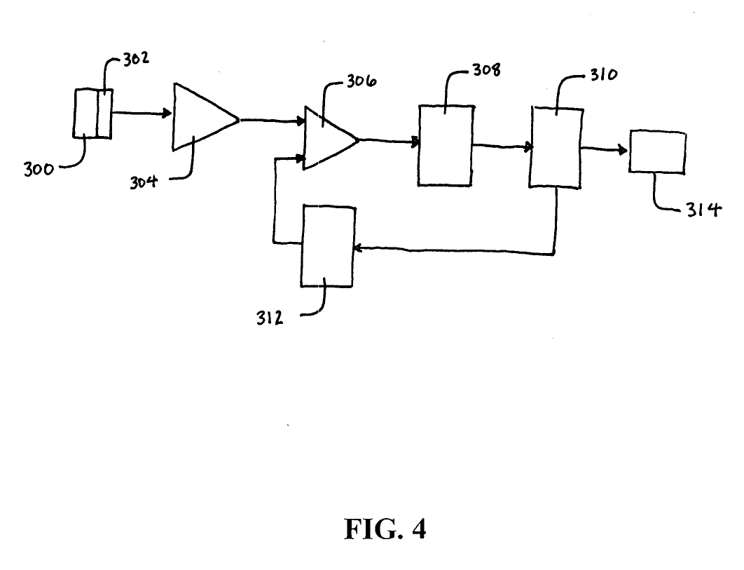

As illustrated in FIG. 4, a component diagram of a moisture detector is shown. Moisture detectors 55 and 57 includes a lamp 300, a detector 302, an amplifier 304, a differential amplifier 306, an analog-to-digital converter 308, a microprocessor or central processing unit 310, a digital-to-analog converter 312, and an output 314.

As described above, lamp 300 emits light that strikes a web, the light then reflecting off of the web and to detector 302. Detector 302 detects the reflected light, such as infrared light, and generates a signal indicative of wavelengths of light detected that is forwarded to amplifier 304. Once the signal is amplified, it is sent to differential amplifier 306. An offset voltage is applied to differential amplifier 306 to produce a differential signal on an input to differential amplifier 306. This signal is amplified and output to analog-to-digital converter 308. Once the signal is converted to digital, it is output to central processing unit 310. Central processing unit 310 contains normalizing software to maintain a fluid offset (reference point or baseline), thereby accounting for variables such as paper change. For example, if the digital signal is recalculated by central processing until 310 every two seconds, and the minimum value of the amplified signal is ten percent different from the previous minimum value, then the offset is changed. The offset signal is preferably just below the value of the amplified signal to permit the system to focus on small changes. Central processing unit 310 also identifies signals indicative of changes in wavelengths of reflected light off of a paper web, such as web 34. Such signals are transmitted via output 314 to a controller, such as controller 64.

It is preferred that moisture detectors 55 and 57 be positioned between 0.1 inches and 15 inches away from web 34. More preferably, moisture detectors 55 and 57 should be positioned 7 inches away from web 34.

The paper on the bridge 42 is removed at a rate that is correlated directly to the amount of bottom liner web 50 that is pulled through the gluing machine 65. Measuring wheel 71 in FIG. 1B makes non-slip contact with bottom liner web 50 and measures the rate that paper is removed from bridge 42. Therefore controller 64 can keep track of the bottom liner paper 50 from the time the web 34 is sprayed at nozzle 72 until the SPRAY is detected at moisture detectors 55 or 57, to determine the quantity of web in the variable-storage bridge 42. Controller 64 adjusts its measurement of the paper in the machine based upon the relative quantities of paper entering the bridge (moving under measuring wheel 71a) and being removed from the bridge (moving under measuring wheel 71c). Controller 64 also adjusts its measurement of the paper in the machine based upon changes in the dancer roll positions 16, 44 and 53 as well as the wrap arm positions 52, 22, 56, 49a and 49b. A second portion of the corrugating machine 10 is illustrated in FIG. 1B. Referring to FIG. 1B, single-faced corrugated web 34 passes from the bridge 42 to an alignment mechanism 45 and then to gluing machine 65. Gluing machine 65 is conventional and may include a pair of adhesive applicator rollers like the rollers 30 which apply adhesive to the corrugated portions of single-faced web 34 and a pair of rollers through which web 34 passes along with a third web after adhesive is applied.

Third splicer 51 supplies a third paper web 50 from a paper roll to a cylindrical roller rotatably supported by a support member attached to a frame portion. Paper web 50 passes through splicer 51 then further passes through positionable dancer roll 53, underneath a pair of positionable cylindrical rollers 56, and over a portion of a pre-heating roller 58 supported by a frame portion. Paper web 50 passes on to bonder 60 where it is bonded to single-faced corrugated web 34 to form single-wall corrugated web 62.

Controller 64 is electronically connected to receive the electrical pulses generated by measuring wheel 71, as well as electrical signals generated by a series of conventional photoelectric detectors 43 disposed on bridge 42 to detect folds 40. By detecting folds 40 on bridge 42, the approximate amount of web 34 present on bridge 42 can be determined. A reflectance detector, such as moisture detectors 55 or 57, can be used to check and refine the readings provided by photoelectric detectors 43 and adjust the readings of photoelectric detectors 43, if required. As discussed above, reflectance detectors, such as moisture detectors 55 or 57, identify the portion of web 34 that was previously sprayed with a water pattern via nozzle 72 by projecting a beam of white light on to web 34. Portions of the visible light spectrum comprising the white light subsequently reflect off of web 34 and are analyzed by detectors 55 or 57. A dry portion of web 34 will have a particular spectral reading different than that of a moistened portion of web 34, since the light reflects differently off of dry and moist paper webs.

The readings taken from photoelectric detectors 43 and reflectance or moisture detectors 55 or 57 are correlated by controller 64 to determine the length of web 34 on bridge 42. By doing so, controller 64 can determine a synchronous splice point so that splicers 12, 41, and 51 can form a synchronous splice. A synchronous splice exists where all three splices are in close proximity to one another, thereby reducing paper waste by requiring fewer cuts to remove the splices from the final product.

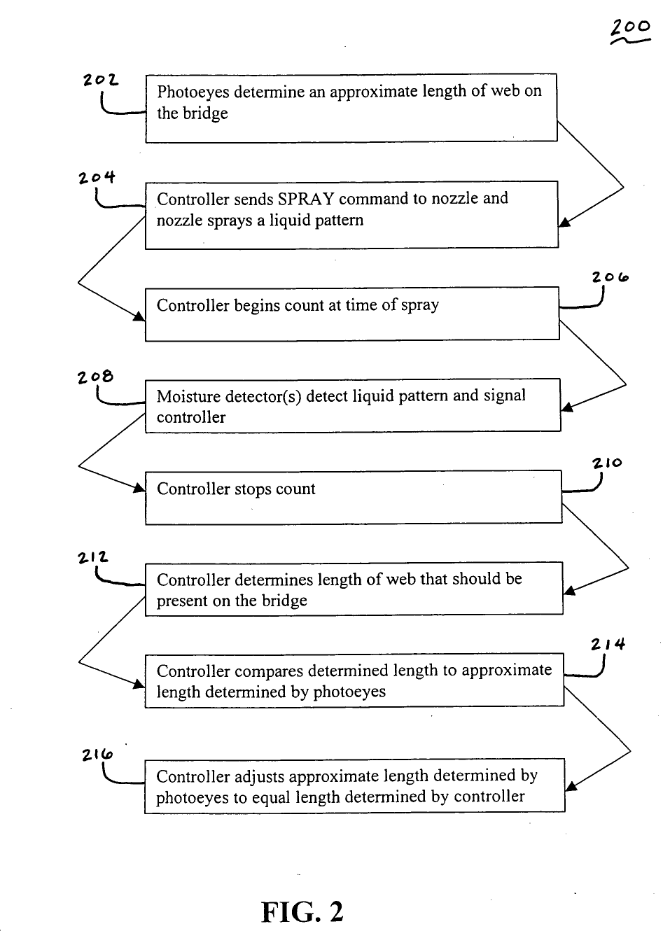

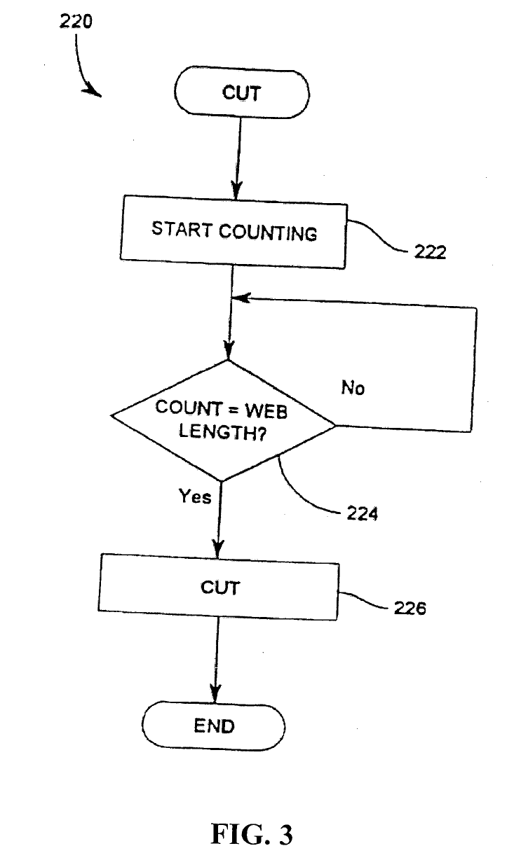

The operation of corrugating machine 10 is described below in connection with FIGS. 2 and 3, which illustrate a portion of the operation of controller 64. Controller 64 may be composed of one or more conventional programmable logic controllers or a conventional computer system, such as a personal computer. Moreover, controller 64 can be networkable, so that it can be accessed and manipulated in real-time over a computer network.

FIG. 2 illustrates a procedure 200 that is periodically performed by the controller 64 to determine the length of web 34 that is on bridge 42. Preferably, procedure 200 is performed at predetermined intervals. Web length may be defined in a number of different ways and is not limited to the length of web 34 that physically lies on top of the bridge 42. Procedure 200 may be performed periodically over a predetermined period.

Referring now to FIG. 2, the first step in procedure 200 is photoeye step 202. Photoeye step 202 engages photoelectric detectors 43 to determine an approximate length of web 34 on bridge 42. Photoelectric detectors 43 make their determination of the length of web 34 on bridge 42 by subtracting the value of web 34 leaving bridge 42 from the value of web 34 coming onto bridge 42 and then adding the resulting value to a predetermined value of web 34 on bridge 42. Once this step 202 is completed, controller 64 can engage step 204.

Step 204 sends a SPRAY command from controller 64 to nozzle 72 that causes nozzle 72 to apply a liquid pattern to a portion of web 34, such as a web face, for a limited duration (as discussed above). In the preferred embodiment a second liquid pattern is applied to web 34 after a period predetermined by the user. A second liquid pattern is applied in an effort to prevent false readings by moisture detectors 55 and 57, as discussed above. Once the first liquid spray of step 204 is completed, controller 64 begins a count, step 206.

As soon as SPRAY command is sent, at step 206 controller 64 begins counting the number of pulses that are being generated by measuring wheel 71c, the pulses generated being directly proportional to the number of rotations of measuring wheel 71c. The controller 64 continues to count the number of pulses until the reflectance or moisture detector 55 or 57 detects the liquid pattern at the spot at which the liquid was sprayed, as determined at step 208, at which point at least one moisture detector signals controller 64 to stop counting the pulses at step 210. Preferably, controller 64 does not stop counting pulses until the second liquid pattern is detected at the predetermined period, thereby avoiding false readings.

Since the spot at which the liquid was sprayed on web 34 gives that wetted portion of the web a reflectance different than that of the dry portion of web 34, controller 64 can determine when the spot is detected by the reflectance or moisture detector 55 or 57 by comparing the electrical signal generated by moisture detector 55 or 57 upon passage of the liquid pattern, which is representative of the moisture of the web 64, with the baseline or offset signal indicative of the reflectance of the web. When the light sensed by moisture detector 55 or 57 falls below the threshold indicative of a moisture level for dry web 34, the spot at which the liquid pattern was sprayed is detected.

Since the detection readings from moisture detector 55 or 57 vary greatly based upon such factors as the type of paper being used, the operating speed (often over 500 feet per minute), and the rate of evaporation of the water from the web, the detection threshold required is constantly recalculated, taking into account the average reading from the detector as well as the total variation in readings from the detector over a period of time. By varying the detection threshold, the areas sprayed with water can be accurately detected. As an additional check, controller 64 only recognizes that the sprayed web has passed under detector 55 when the pattern of spray pulses matches what was sprayed (after correcting for variation in operating speed from when the web was sprayed and when the spray was detected).

At step 212, controller 64 determines the length of the web 34 in the bridge 42 by taking the reading of moisture detector 55 or 57, in conjunction with the number of pulses from measuring wheel 71c counted by the controller 64 between the spraying of the liquid and the detection of the spot, and correlating the reading to the readings of photoelectric detectors 43. That number of pulses corresponds to the current length of web 34 from nozzle 72 to the reflectance or moisture detector 55 or 57. This determined length is compared to the length approximated by photoelectric detectors 43 on bridge 42 at step 214 and, in step 216, controller 64 continuously adjusts photoelectric detectors 43 or the measurements taken by photoelectric detectors 43.

The length of web 34 on bridge 42 periodically calculated via the procedure illustrated in FIG. 2 and described above is used to perform a series of functions. One function being a cutting procedure 220 which controls when the cutter cuts out an extra-thick portion of the single-wall corrugated web 62 which is generated by a synchronous splice, and triggers an order change. Another reason for the synchronized splice is to reduce waste from mixing uncalled-for paper types together, a procedure that is normally unusable. Another advantage for synchronization occurs when paper widths change. Mixing unlike paper widths can cause several problems. These problems include, but are not limited to, jams at web guides, smearing glue on machinery, and jams when dry end order changes are performed.

Referring to FIG. 3, when either one of the splicers 12 or 41 splices a new web onto the current web, a SPLICE signal is transmitted to the controller 64. As soon as the SPLICE signal is received, the controller 64 starts counting the number of pulses received from the measuring wheel.

It should be understood that the total length of the web from either of the two splicers 12, 41 to the cutter is always known with the controller of the present invention. Although the web length from one of the splicers to the bridge 42 is variable, due to the ability of controller 64 to reposition dancer rolls 16, 44, and 53 as well as pre-heater arms 22 and 56, controller 64 can determine the web length from the amount or extent that dancer rolls 16, 44, and 53 and pre-heater wrap arms 22 and 56 are moved. Sensors (not shown), such as variable potentiometers, pulse wheels, or load cells, engage dancer rolls 16, 44, and 53 and pre-heater wrap arms 22 and 56. The sensors engaging dancer rolls 16, 44, and 53 and preheater wrap arms 22 and 56 are used to detect, via changes in electrical potentials (as is well known in the art) in dancer rolls 16, 44, and 53 and pre-heater wrap arms 22 and 56, their respective positions in corrugating machine 10. The values of the electrical potentials for dancer rolls 16, 44, and 53 are indicative of a distance of dancer rolls 16, 44, and 53 relative to their respective positions along corrugating machine 10. Similarly, the values of the electrical potentials for pre-heater wrap arms 22 and 56 are indicative of a distance of pre-heater wrap arms 22 and 56 relative to their respective positions about preheating rollers 24 and 58.

Controller 64 is electrically engaged to the sensors as well, and is thus constantly fed position data of dancer rolls 16, 44, and 53 and pre-heater wrap arms 22 and 56 from the sensors. Controller 64 uses the position data to continuously determine the amount of paper going through corrugating machine 10. Moreover, the position data from individual sensors can be used by controller 64 to calculate the amount of paper in a particular segment of corrugating machine 10. Additionally, by positioning a plurality measuring wheels 71 at specific segments of corrugating machine 10, as illustrated in FIGS. 1A and 1B, controller 64 can further monitor the length of each paper web as the paper webs pass through corrugating machine 10.

By correlating the readings of photoelectric detectors 43 with the readings of the plurality of measuring wheels 71 and moisture detectors 55 and 57, controller 64 can create a synchronous splice by adjusting the delivery of paper webs 14, 32, and/or 50. The adjustment of paper webs 14, 32, and/or 50 can be accomplished by, but is not limited to manipulating the position of dancer rolls, such as dancer rolls 16, 44, and/or 53, manipulating the position of preheater arms, such as preheater roller arms 22, and adjusting the speeds of the paper webs.

At step 224, when the number of pulses being counted at step 222 reaches a predetermined number of pulses corresponding to a length slightly shorter than the total length of the web from one of the splicers 12, 41 to the cutter, then at step 226 controller 64 sends a CUT signal to the cutter. In response to the CUT signal, the cutter makes a first cut in double-faced corrugated web 62, waits a predetermined period of time and then makes a second cut in the double-faced corrugated web 62 a predetermined distance after the first cut, so that the extra-thick spliced portion is cut out of web 62.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A control system for a corrugating machine, comprising:
a first positionable dancer roll for manipulating a first paper web operatively engaged to a controller;
a first positionable pre-heater wraparm for adjusting an amount of said first paper web in contact with said positionable pre-heater operatively engaged to said controller;
a second positionable dancer roll for manipulating a second paper web operatively engaged to said controller;
a second positionable pre-heater wraparm for adjusting an amount of said second paper web in contact with said positionable pre-heater operatively engaged to said controller;
a roller assembly for corrugating said second paper web and adhering said first paper web to said second paper web to form layered paper web;
a moisture applicator for applying moisture to said first paper web and operatively engaged to said controller;
a bridge for temporarily storing said layered paper web;
a plurality of photoelectric detectors positioned on said bridge of said corrugating machine and operatively engaged to said controller;
a moisture detector to detect the presence of moisture of said first paper web and operatively engaged to said controller, wherein said moisture detector calibrates said plurality of photoelectric detectors;
at least one splicer operatively engaged to said controller for cutting out a portion of said layered paper web at a synchronized splice point, wherein said synchronized splice point is determined by correlating said plurality of photoelectric detectors with said moisture detector.

2. The control system according to claim 1 wherein said controller is a programmable logic controller.

3. The control system according to claim 2 wherein said programmable logic controller is in communication with a computer network.

4. The control system according to claim 1 wherein said moisture applicator applies moisture for less than about one-half of a second.

5. The control system according to claim 1 wherein said moisture applicator applies moisture for less than about one-sixth of a second.

6. The control system according to claim 1 wherein said moisture applicator applies moisture to said first paper web.

7. The control system according to claim 1 wherein said plurality of photoelectric detectors detects folds of said layered paper web on said bridge.

8. The control system according to claim 7 wherein said plurality of photoelectric detectors determines an approximate length of said layered paper web on said bridge.

9. The control system according to claim 1 wherein said moisture detector detects moisture by identifying changes in reflectance of said first paper web.

10. The control system according to claim 1 wherein said moisture detector is positioned less than about 15″ from said first paper web.

11. The control system according to claim 1 wherein said moisture detector is positioned less than about 7″ from said first paper web.

12. A method for determining a length of paper web in a corrugating machine having a bridge, said method comprising the steps of:
calculating an approximate length of said paper web on said bridge using photoelectric detectors;
applying a liquid pattern on a portion of said paper web for a short duration;
initiating a count at said application of said liquid pattern;
detecting said liquid pattern with a moisture detector;
terminating said count at said detection of said liquid pattern;
calculating a determined length of said paper web based on said count and said detection of said liquid pattern;
comparing said determined length to said approximate length; and
adjusting said approximate length to equal said determined length.

13. The method according to claim 12 wherein said approximate length is calculated by subtracting an amount of paper web exiting said bridge from an amount of paper web entering said bridge and adding a predetermined value of an amount of paper web on said bridge thereto.

14. The method according to claim 12 wherein said count is initiated by a controller.

15. The method according to claim 14 wherein said controller is a programmable logic controller.

16. The method according to claim 15 wherein said programmable logic controller is in communication with a computer network.

17. The method according to claim 12 wherein said moisture detector detects moisture by identifying changes in reflectance of said paper web.

18. The method according to claim 14 wherein said count is terminated by said controller.

19. The method according to claim 18 wherein said controller is a programmable logic controller.

20. The method according to claim 19 wherein said programmable logic controller is in communication with a computer network.

21. The method according to claim 14 wherein said controller is in communication with said moisture detector.

22. The method according to claim 18 wherein said controller is in communication with said moisture detector.

23. The method according to claim 18 wherein said controller calculates said determined length of said paper web based on said count and said detection of said liquid pattern.

24. The method according to claim 23 wherein said controller compares said determined length to said approximate length.

25. The method according to claim 24 wherein said controller is operatively engaged to said photoelectric detectors and adjusts said approximate length to said determined length.

26. The method according to claim 25 wherein said controller is a programmable logic controller.

27. The method according to claim 26 wherein said programmable logic controller is in communication with a computer network.

28. A moisture detector for a control system for a corrugating machine, comprising:
a lamp for emitting light towards a paper web;
a detector for detecting wavelengths of said light reflected off of said paper web, said detector generating an electrical signal indicative of said wavelengths of said reflected light;
an amplifier in electrical communication with said detector, said amplifier amplifying said electrical signal;
a differential amplifier in electrical communication with said amplifier, said differential amplifier receiving said electrical signal and differentially amplifying said electrical signal;
an analog-to-digital converter in electrical communication with said differential amplifier, said analog-to-digital converter converting said differentially amplified electrical signal to a digital signal indicative of said wavelengths of said reflected light;
a central processing unit in electrical communication with said analog-to-digital converter, said central processing unit receiving said digital signal and containing software to maintain a fluid offset and identifying said digital signal indicative of said wavelengths of said reflected light; and
wherein said central processing unit includes an output to transmit said digital signal indicative of said wavelengths of said reflected light to a controller.

29. The moisture detector according to claim 28 wherein said controller is a programmable logic controller.

30. The moisture detector according to claim 29 wherein said programmable logic controller is in communication with a computer network.

31. A method for determining a length of paper web in a corrugating machine having a bridge, said method comprising the steps of:
applying a liquid pattern on a portion of said paper web for a short duration;
initiating a count at said application of said liquid pattern;
detecting said liquid pattern;
terminating said count at said detection of said liquid pattern; and
calculating a determined length of said paper web based on said count and said detection of said liquid pattern.

32. The method according to claim 31 further comprising the steps of:
calculating an approximate length of said paper web;
comparing said determined length to said approximate length; and
adjusting said approximate length to equal said determined length.

33. The method according to claim 31 wherein said liquid pattern is detected with a moisture detector.

34. The method according to claim 32 wherein said approximate length of said paper web is calculated by photoelectric detectors.

35. The method according to claim 34 wherein said photoelectric detectors calculate said approximate length by subtracting an amount of paper web exiting said bridge from an amount of paper web entering said bridge and adding a predetermined value of an amount of paper web on said bridge thereto.

36. The method according to claim 31 wherein said count is initiated by a controller.

37. The method according to claim 36 wherein said controller is a programmable logic controller.

38. The method according to claim 37 wherein said programmable logic controller is in communication with a computer network.

39. The method according to claim 31 wherein said moisture detector detects moisture by identifying changes in reflectance of said paper web.

40. The method according to claim 36 wherein said count is terminated by said controller.

41. The method according to claim 40 wherein said controller is a programmable logic controller.

42. The method according to claim 41 wherein said programmable logic controller is in communication with a computer network.

43. The method according to claim 36 wherein said controller is in communication with said moisture detector.

44. The method according to claim 40 wherein said controller is in communication with said moisture detector.

45. The method according to claim 36 wherein said controller calculates said determined length of said paper web based on said count and said detection of said liquid pattern.

46. The method according to claim 32 wherein said controller compares said determined length to said approximate length.

47. The method according to claim 46 wherein said controller is operatively engaged to said photoelectric detectors and adjusts said approximate length to said determined length.

48. The method according to claim 47 wherein said controller is a programmable logic controller.

49. The method according to claim 48 wherein said programmable logic controller is in communication with a computer network.
